(19) United States
(12) Patent Application Publication
(10) Pub. No.: US 2024/0317104 A1
(43) Pub. Date: Sep. 26, 2024

(54) Hot Swappable Power System

(71) Applicant: Black-I Robotics, Inc., Tyngsboro, MA (US)

(72) Inventors: Brian T. Hart, Bedford, MA (US); Mischa deRuijter, Harvard, MA (US)

(21) Appl. No.: 18/614,325

(22) Filed: Mar. 22, 2024

Related U.S. Application Data
(60) Provisional application No. 63/491,898, filed on Mar. 23, 2023.

(51) Int. Cl. B60L 53/80; B25J 19/00; H01M 50/244; H01M 50/264; H02J 7/00

(52) U.S. Cl. CPC B60L 53/80; B25J 19/005; H01M 50/244; H01M 50/264; H02J 7/0025; H01M 2220/20

(57) ABSTRACT

A hot-swappable power system includes: a hot-swappable power module that includes one or more batteries and is configured to provide electrical power to an autonomous robotic system; and a power module receiver configured to receive the hot-swappable power module and releasably electrically couple the hot-swappable power module to a primary energy source of the autonomous robotic system.

### RELATED APPLICATION(S)

This application claims the benefit of the following: U.S. Provisional Application No. 63/491,898, filed on 23 Mar. 2023, the entire contents of which are incorporated herein by reference.

### TECHNICAL FIELD

This disclosure relates to hot-swappable power systems and, more particularly, to hot-swappable power systems for use on autonomous robotic systems.

### BACKGROUND

Autonomous robots, machines designed to perform tasks with high degrees of autonomy, have been evolving for decades. The concept of a machine capable of performing tasks without human intervention traces back to the early 20th century, with significant advancements occurring during the latter half of the century. Initially, these robots were simple, performing basic tasks in controlled environments, such as manufacturing lines. However, with the advent of computer technology, artificial intelligence (AI), and robotics in the latter 20th and early 21st centuries, the capabilities and applications of autonomous robots expanded dramatically.

The development of autonomous robots has been driven by the need to perform tasks that are dangerous, tedious, or impossible for humans. This includes everything from deep-sea exploration and space missions to mundane household chores. The key to autonomy lies in the robots' ability to sense their environment, process information, and take action without human guidance. This requires sophisticated sensors, processors, and algorithms. Machine learning and AI have played pivotal roles in advancing these capabilities, enabling robots to learn from their environment and make increasingly complex decisions.

Power supplies are a critical component of autonomous robots, as they determine how long a robot can operate before needing a recharge. The choice of power supply depends on the robot's size, operational environment, and the duration it is expected to perform tasks. Early autonomous robots were often tethered to a power source, severely limiting their range and mobility. As technology progressed, onboard power sources became more common, with batteries being the most widespread option.

Batteries, especially rechargeable ones like lithium-ion, have been the cornerstone of mobile robot power supplies. Generally speaking, batteries allow autonomous robots to receive onboard power, untethered to shore power, which is critical for uninhibited mobility. They offer a good balance between weight and energy capacity, which is crucial for maintaining the efficiency and mobility of the robot. Advances in battery technology have continuously improved energy density, lifecycle, and recharge times, significantly enhancing the operational capability of autonomous robots.

In conclusion, the background of autonomous robots is a testament to the incredible advancements in technology over the past century. From their inception to the present day, these robots have become increasingly sophisticated, capable of performing a wide range of tasks with minimal human intervention. Power supply technology has evolved in tandem, supporting the autonomy of these machines through innovations in battery technology and the development of more efficient charging methods. As both fields continue to advance, the capabilities and applications of autonomous robots are set to expand even further, pushing the boundaries of what is possible.

### SUMMARY OF DISCLOSURE

In one implementation, a hot-swappable power system includes: a hot-swappable power module that includes one or more batteries and is configured to provide electrical power to an autonomous robotic system; and a power module receiver configured to receive the hot-swappable power module and releasably electrically couple the hot-swappable power module to a primary energy source of the autonomous robotic system.

One or more of the following features may be included. The autonomous robotic system may include an autonomous mobile robot. The autonomous mobile robot may be powered by the primary energy source. The hot-swappable power module may be configured to provide the electrical power to the primary energy source of the autonomous mobile robot. The autonomous robotic system may include a robotic arm system. The robotic arm system may be powered by the primary energy source. The hot-swappable power module may be configured to provide the electrical power to the primary energy source of the robotic arm system. The hot-swappable power module may include a battery tray to mount the one or more batteries. The power module receiver may be configured to releasably receive the battery tray.

In another implementation, a hot-swappable power system includes: a hot-swappable power module that includes one or more batteries and is configured to provide electrical power to an autonomous robotic system; and a power module receiver configured to receive the hot-swappable power module and releasably electrically couple the hot-swappable power module to a primary energy source of the autonomous robotic system; wherein the autonomous robotic system includes an autonomous mobile robot.

One or more of the following features may be included. The autonomous mobile robot may be powered by the primary energy source. The hot-swappable power module may be configured to provide the electrical power to the primary energy source of the autonomous mobile robot. The autonomous robotic system may also include a robotic arm system. The robotic arm system may be powered by the primary energy source of the autonomous mobile robot. The hot-swappable power module may include a battery tray to mount the one or more batteries. The power module receiver may be configured to releasably receive the battery tray.

In another implementation, a hot-swappable power system includes: a hot-swappable power module that includes one or more batteries and is configured to provide electrical power to an autonomous robotic system; and a power module receiver configured to receive the hot-swappable power module and releasably electrically couple the hot-swappable power module to a primary energy source of the autonomous robotic system; wherein the autonomous robotic system includes a robotic arm system.

One or more of the following features may be included. The robotic arm system may be powered by the primary energy source. The hot-swappable power module may be configured to provide the electrical power to the primary energy source of the robotic arm system. The autonomous robotic system may also include an autonomous mobile robot. The autonomous mobile robot may be powered by the primary energy source of the robotic arm system. The hot-swappable power module may include a battery tray to mount the one or more batteries. The power module receiver may be configured to releasably receive the battery tray.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of an autonomous robotic system according to an embodiment of the present disclosure; and

FIGS. 2-4 are diagrammatic views of a hot-swappable power system for use with the autonomous robotic system of FIG. 1 according to an embodiment of the present disclosure.

Like reference symbols in the various drawings indicate like elements.

### DETAILED DESCRIPTION OF THE PREFERRED EMBODIMENTS

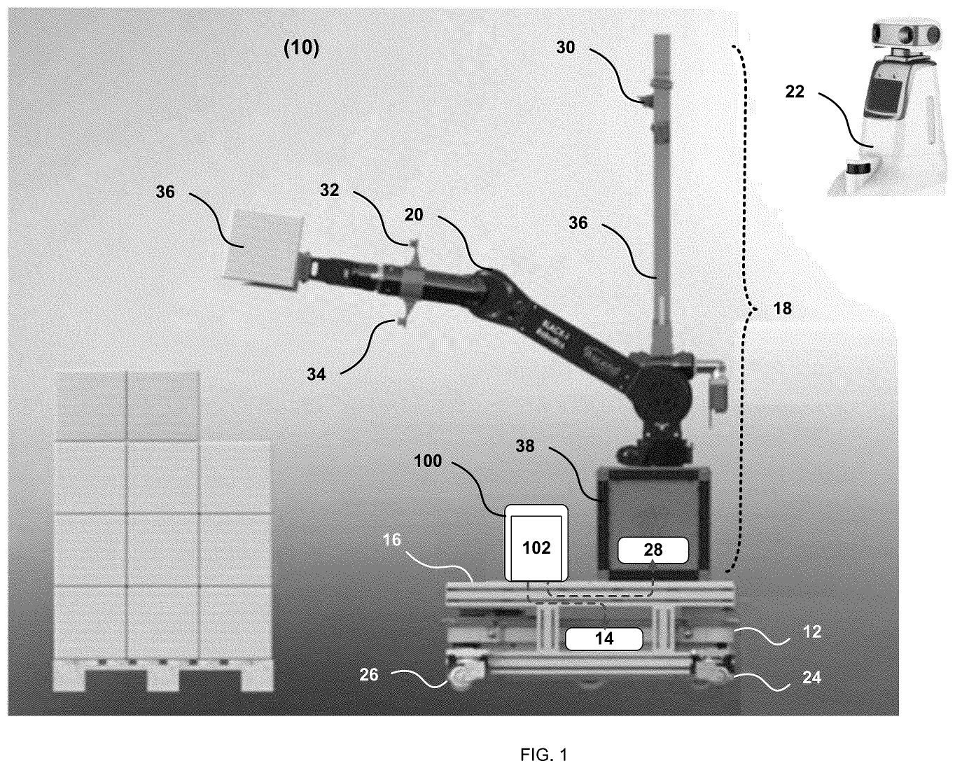

Referring to FIG. 1, there is shown an autonomous robotic system (e.g., autonomous robotic system 10). The autonomous robotic system (e.g., autonomous robotic system 10) may include an autonomous mobile robot (e.g., autonomous mobile robot 12).

An autonomous mobile robot (e.g., autonomous mobile robot 12) is a type of robot designed to perform tasks with high levels of autonomy. These robots can navigate and operate in complex, dynamic environments without continuous human guidance. AMRs are equipped with an array of sensors, processors, and software algorithms that enable them to perceive their surroundings, make decisions, and execute tasks. This capability allows them to autonomously navigate through different terrains and environments, avoiding obstacles, adapting to changes, and completing designated tasks efficiently.

The core technologies enabling AMRs include robotics, artificial intelligence (AI), machine learning, and sensor technology. These robots use sensors such as LiDAR, cameras, GPS, and inertial measurement units to understand and interact with their environment. Advanced AI algorithms process this sensor data, allowing the robot to map its environment, plan paths, and make real-time decisions. Machine learning enables these robots to improve their performance over time based on past experiences and data collected during their operations.

AMRs are employed across various sectors, including logistics and warehousing, manufacturing, healthcare, and agriculture, for tasks such as material handling, delivery, surveillance, and crop monitoring. Their ability to operate autonomously reduces the need for human labor in mundane or dangerous tasks, increases efficiency, and can lead to significant cost savings for businesses. As technology advances, the capabilities and applications of autonomous mobile robots continue to expand, promising to play an increasingly significant role in various industries and aspects of daily life.

The autonomous mobile robot (e.g., autonomous mobile robot 12) may be powered by the primary energy source (e.g., primary energy source 14). Autonomous mobile robot (e.g., autonomous mobile robot 12) may rely on various power sources to operate, examples of which may include but are not limited to battery systems. The choice of battery systems may impact the robot's operational efficiency, runtime, and overall performance.

Some common battery sources (e.g., primary energy source 14) may include:
Lithium-Ion Batteries (Li-ion): These are the most popular choice for AMRs due to their high energy density, which means they can store more energy for their size and weight than other types of batteries. Li-ion batteries also have a relatively long lifecycle, can be charged quickly, and have a low self-discharge rate. Their efficiency and longevity make them suitable for applications requiring long periods of use and minimal downtime.
Nickel-Metal Hydride Batteries (NiMH): Before the widespread adoption of Li-ion technology, NiMH batteries were commonly used in various types of robots. They offer a good balance between cost and performance, with a moderate energy density and a relatively environmentally friendly profile due to the absence of toxic metals. However, they are less favored now due to their heavier weight and lower energy efficiency compared to Li-ion batteries.
Lead-Acid Batteries: Known for their robustness and low cost, lead-acid batteries have been used in larger, industrial-type AMRs, particularly where weight is not a significant issue, and high-power output is required for short durations. They are less energy-efficient and have a shorter lifecycle compared to Li-ion and NiMH batteries, making them less suitable for applications requiring frequent charging and long operational hours.
Lithium Polymer Batteries (LiPo): LiPo batteries offer a higher energy density than Li-ion and can be made in almost any shape or size. They are lightweight and have a high discharge rate, making them ideal for applications needing a quick power supply. However, they can be more expensive and require careful handling and charging practices to prevent issues like swelling and potential fires.
Solid-State Batteries: This is an emerging technology that promises higher energy densities, longer lifecycles, and enhanced safety features over traditional Li-ion batteries. Solid-state batteries use a solid electrolyte instead of a liquid one, potentially reducing the risk of leaks and fires. While not yet widely adopted in AMRs due to current technological and cost barriers, they represent a promising future direction for robot power supplies.

The choice of battery (e.g., primary energy source 14) for an autonomous mobile robot (e.g., autonomous mobile robot 12) depends on various factors, including the specific application requirements, operational environment, expected runtimes, and cost considerations. As battery technology continues to evolve, advancements in energy density, safety, and sustainability can be expected, further expanding the capabilities and applications of autonomous mobile robots (e.g., autonomous mobile robot 12).

The autonomous robotic system (e.g., autonomous robotic system 10) may include a robot accessory mounting cart (e.g., robot accessory mounting cart 16). The robot accessory mounting cart (e.g., robot accessory mounting cart 16) may be configured to receive one or more accessories (e.g., accessories 18) configured to work with the autonomous mobile robot (e.g., autonomous mobile robot 12), wherein examples of such accessories (e.g., accessories 18) may include but are not limited to a robotic arm system (e.g., robotic arm system 20) for lifting/moving objects, and a monitoring system (e.g., monitoring system 22) for monitoring/patrolling space.

The robot accessory mounting cart (e.g., robot accessory mounting cart 16) may include one or more outrigger wheels (e.g., outrigger wheels 24, 26). These outrigger wheels (e.g., outrigger wheels 24, 26) may be configured to serve various purposes, such as partially supporting the weight of the accessories (e.g., accessories 18) attached to the autonomous robotic system (e.g., autonomous robotic system 10) and/or providing additional stability by widening the track width of the autonomous robotic system (e.g., autonomous robotic system 10).

The robotic arm system (e.g., robotic arm system 20) and/or the monitoring system (e.g., monitoring system 22) may be powered by a primary energy source (e.g., primary energy source 28). Examples of such a primary energy source (e.g., primary energy source 28) may include: Lithium-Ion Batteries (Li-ion); Nickel-Metal Hydride Batteries (NiMH); Lead-Acid Batteries; Lithium Polymer Batteries (LiPo); and Solid-State Batteries.

The robotic arm system (e.g., robotic arm system 20) may include machine vision system 30. An example of such a machine vision system (e.g., machine vision system 30) may include but is not limited to the Intel® RealSense™ D435 depth camera. The machine vision system (e.g., machine vision system 30) may be configured to include multiple/additional machine vision systems (e.g., multiple/additional cameras 32, 34). Accordingly, these one or more additional cameras may be positioned along the robotic arm system (e.g., robotic arm system 20). For example, these additional cameras (e.g., multiple/additional cameras 32, 34) may be mounted on the robotic arm system (e.g., robotic arm system 20) and may provide visual target identification for pick-up and/or positioning of e.g., object 36, as well as proximate object detection to allow for safe operation of the robotic arm system (e.g., robotic arm system 20) near moving and stationary objects.

To properly position machine vision system 30 with respect to the robotic arm system (e.g., robotic arm system 20) and/or the autonomous robotic system (e.g., autonomous robotic system 10), machine vision system 30 may be mounted on mast assembly 36 coupled (i.e., directly or indirectly) to the robotic arm system (e.g., robotic arm system 20) and/or the autonomous robotic system (e.g., autonomous robotic system 10). Through the use of mast assembly 36, an elevated point of view may be achieved with respect to the moving parts of the robotic arm system (e.g., robotic arm system 20) and/or the autonomous robotic system (e.g., autonomous robotic system 10), thus providing situational awareness to avoid collision and/or permit safe operation by humans within the reachable proximity of the moving parts of the robotic arm system (e.g., robotic arm system 20) and/or its payload.

The robotic arm system (e.g., robotic arm system 20) may include various operational control systems (e.g., operational control systems 38), examples of which may include but are not limited to electrical control systems, pneumatic control systems, and hydraulic control systems.

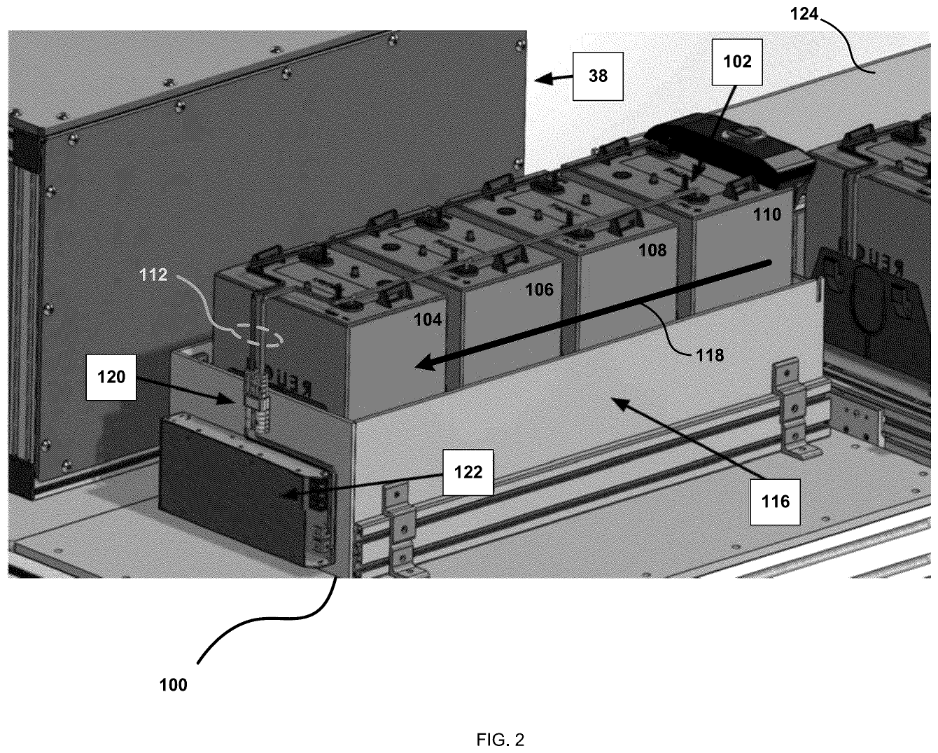

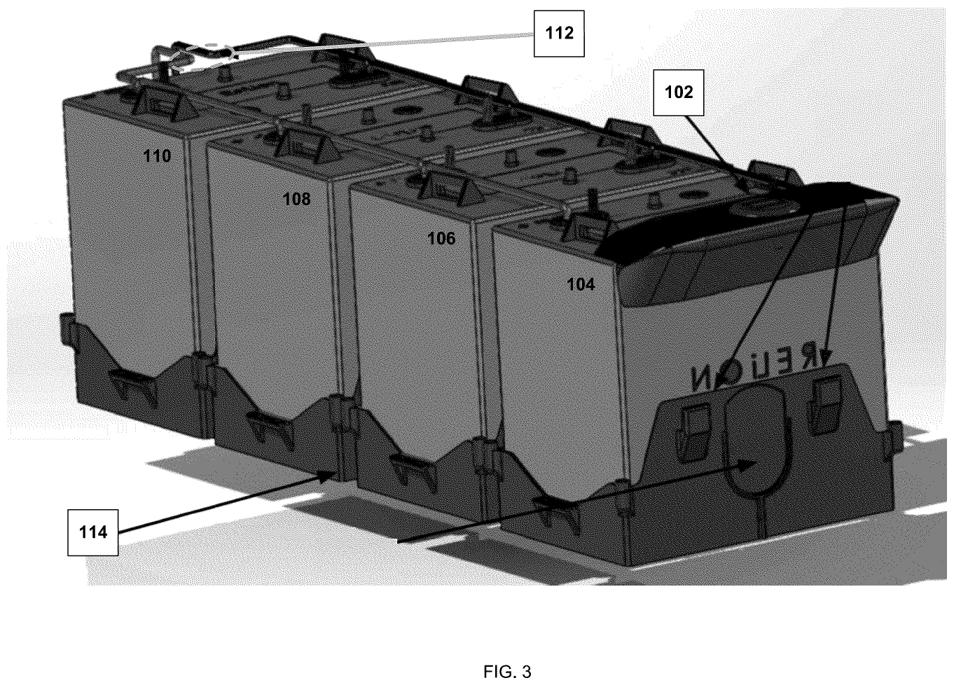

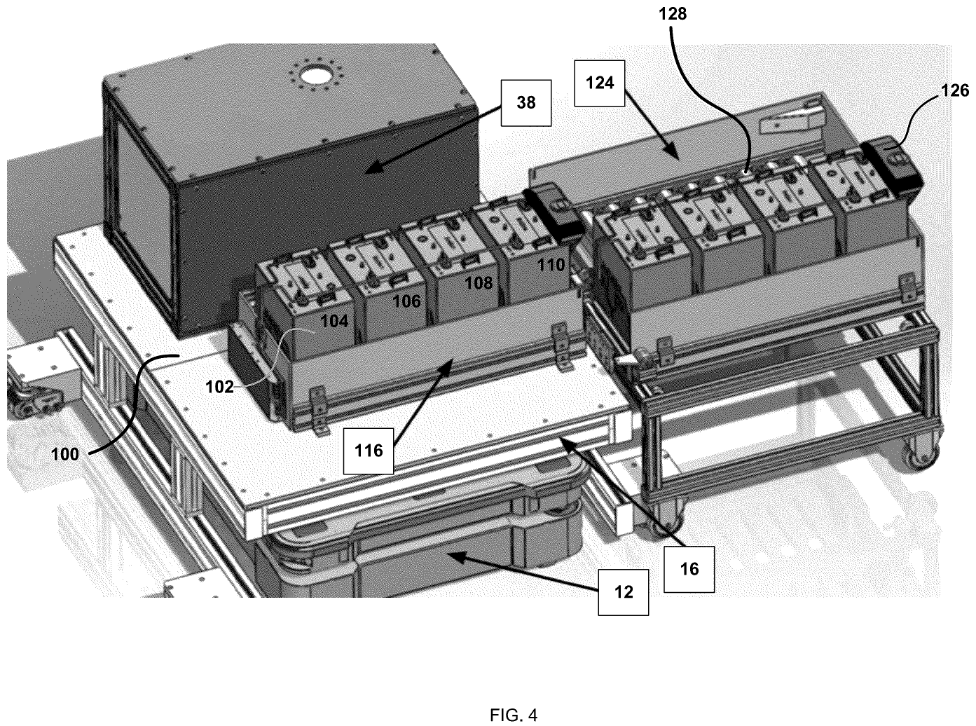

Referring also to FIGS. 2-4, the autonomous robotic system (e.g., autonomous robotic system 10) may include a hot-swappable power system (e.g., hot-swappable power system 100). Hot-swappable power system 100 is generally designed to eliminate power-related downtime and ensure maximum power availability. A hot-swappable power system (e.g., hot-swappable power system 100) may allow for seamless replacement without interrupting the normal operation of the system (e.g., autonomous robotic system 10). Using a hot-swapping system, power sources can be replaced with fresh ones while the equipment (e.g., autonomous robotic system 10) remains operating. As will be discussed below in greater detail and through the use of the hot-swappable power system (e.g., hot-swappable power system 100), the autonomous robotic system (e.g., autonomous robotic system 10) may continue to operate in an uninterrupted fashion without concern for the primary energy source (e.g., primary energy source 14 and/or primary energy source 28) of the autonomous robotic system (e.g., autonomous robotic system 10) becoming exhausted, as the hot-swappable power system (e.g., hot-swappable power system 100) may be configured to replenish one or more of these primary energy sources (e.g., primary energy source 14 and/or primary energy source 28) while some or all of the autonomous robotic system (e.g., autonomous robotic system 10) continues to operate. Accordingly and through the use of such a system (e.g., hot-swappable power system 100), the need for an autonomous mobile robot to return to a stationary recharging/docking station (that is connected to shore power) can be eliminated.

The hot-swappable power system (e.g., hot-swappable power system 100) may include a hot-swappable power module (e.g., hot-swappable power module 102) that includes one or more batteries (e.g., batteries 104, 106, 108, 110) and may be configured to provide electrical power (e.g., electrical power 112) to the autonomous robotic system (e.g., autonomous robotic system 10). In one embodiment, the hot-swappable power module (e.g., hot-swappable power module 102) may include a battery tray (e.g., battery tray 114) configured to mount the one or more batteries (e.g., batteries 104, 106, 108, 110). Autonomous mobile robot 12 may be powered by 48 VDC batteries, wherein each of batteries 104, 106, 108, 110 may be wired in a parallel arrangement to enhance AMP hours. Robotic arm system 20 may also be powered by 48 VDC power.

The hot-swappable power system (e.g., hot-swappable power system 100) may also include a power module receiver (e.g., power module receiver 116) configured to receive the hot-swappable power module (e.g., hot-swappable power module 102) and releasably electrically couple the hot-swappable power module (e.g., hot-swappable power module 102) to a primary energy source (e.g., primary energy source 14 and/or primary energy source 28) of the autonomous robotic system (e.g., autonomous robotic system 10). In one embodiment, the power module receiver (e.g., power module receiver 116) may be configured to releasably receive the battery tray (e.g., battery tray 114).

Accordingly, the battery tray (e.g., battery tray 114) of the hot-swappable power module (e.g., hot-swappable power module 102), which contains one or more batteries (e.g., batteries 104, 106, 108, 110), may be configured to slide into the power module receiver (e.g., power module receiver 116) in the direction of arrow 118 so that electrical contact may be made (e.g., between connector assemblies 120, 122) so that electrical power (e.g., electrical power 112) may be provided to the primary energy source (e.g., primary energy source 14 and/or primary energy source 28) to effectuate the charging of the same.

The insertion and the removal of the battery tray (e.g., battery tray 118) of the hot-swappable power module (e.g., hot-swappable power module 102) with respect to the power module receiver (e.g., power module receiver 116) may be accomplished via a manual or an automated operation. For example, a freshly-charged, hot-swappable power module (e.g., hot-swappable power module 102) may be manually wheeled to the autonomous robotic system (e.g., autonomous robotic system 10) on e.g., module cart 124 and a depleted hot-swappable power module (e.g., depleted hot-swappable power module 126) may be swapped with the freshly-charged, hot-swappable power module (e.g., hot-swappable power module 102). Additionally/alternatively, a freshly-charged, hot-swappable power module (e.g., hot-swappable power module 102) may be brought (e.g., via an autonomous mobile robot) to the autonomous robotic system (e.g., autonomous robotic system 10) and a depleted hot-swappable power module (e.g., depleted hot-swappable power module 126) may be automatically swapped with the freshly-charged, hot-swappable power module (e.g., hot-swappable power module 102). Once on module cart 124, depleted hot-swappable power module 126 may be rolled to a remote charging station (not shown) so that depleted hot-swappable power module 126 may be recharged/replenished while remaining on module cart 124, thus eliminating the need to lift depleted hot-swappable power module 126 (which may weigh over 200 pounds). The battery tray (e.g., battery tray 114) may be supported by conveyor rollers (e.g., conveyor rollers 128), wherein these conveyor rollers (e.g., conveyor rollers 128) may allow battery tray 114 to roll off module cart 124 without lifting battery tray 114. These rollers (e.g., conveyor rollers 128) may be free-wheeling or electrically powered.

Accordingly, the hot-swappable power module (e.g., hot-swappable power module 102) may be configured to provide the electrical power (e.g., electrical power 112) to the primary energy source (e.g., primary energy source 14) of the autonomous mobile robot (e.g., autonomous mobile robot 12) so that the primary energy source (e.g., primary energy source 14) of the autonomous mobile robot (e.g., autonomous mobile robot 12) may be charged while the autonomous mobile robot (e.g., autonomous mobile robot 12) continues to operate. Additionally, the primary energy source (e.g., primary energy source 14) of the autonomous mobile robot (e.g., autonomous mobile robot 12) may be configured to also power the robotic arm system (e.g., robotic arm system 20).

Further, the hot-swappable power module (e.g., hot-swappable power module 102) may be configured to provide the electrical power (e.g., electrical power 112) to the primary energy source (e.g., primary energy source 28) of the robotic arm system (e.g., robotic arm system 20) so that the primary energy source (e.g., primary energy source 28) of the robotic arm system (e.g., robotic arm system 20) may be charged while the robotic arm system (e.g., robotic arm system 20) continues to operate. Additionally, the primary energy source (e.g., primary energy source 28) of the robotic arm system (e.g., robotic arm system 20) may be configured to also power the autonomous mobile robot (e.g., autonomous mobile robot 12).

### GENERAL

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block or blocks.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A hot-swappable power system comprising:
a hot-swappable power module that includes one or more batteries and is configured to provide electrical power to an autonomous robotic system; and
a power module receiver configured to receive the hot-swappable power module and releasably electrically couple the hot-swappable power module to a primary energy source of the autonomous robotic system.

2. The hot-swappable power system of claim 1 wherein the autonomous robotic system includes an autonomous mobile robot.

3. The hot-swappable power system of claim 2 wherein the autonomous mobile robot is powered by the primary energy source.

4. The hot-swappable power system of claim 3 wherein the hot-swappable power module is configured to provide the electrical power to the primary energy source of the autonomous mobile robot

5. The hot-swappable power system of claim 1 wherein the autonomous robotic system includes a robotic arm system

6. The hot-swappable power system of claim 5 wherein the robotic arm system is powered by the primary energy source.

7. The hot-swappable power system of claim 6 wherein the hot-swappable power module is configured to provide the electrical power to the primary energy source of the robotic arm system

8. The hot-swappable power system of claim 1 wherein the hot-swappable power module includes a battery tray to mount the one or more batteries

9. The hot-swappable power system of claim 8 wherein the power module receiver is configured to releasably receive the battery tray.

10. A hot-swappable power system comprising:
a hot-swappable power module that includes one or more batteries and is configured to provide electrical power to an autonomous robotic system; and
a power module receiver configured to receive the hot-swappable power module and releasably electrically couple the hot-swappable power module to a primary energy source of the autonomous robotic system;
wherein the autonomous robotic system includes an autonomous mobile robot.

11. The hot-swappable power system of claim 10 wherein the autonomous mobile robot is powered by the primary energy source.

12. The hot-swappable power system of claim 11 wherein the hot-swappable power module is configured to provide the electrical power to the primary energy source of the autonomous mobile robot

13. The hot-swappable power system of claim 12 wherein the autonomous robotic system also includes a robotic arm system.

14. The hot-swappable power system of claim 13 wherein the robotic arm system is powered by the primary energy source of the autonomous mobile robot.

15. The hot-swappable power system of claim 10 wherein the hot-swappable power module includes a battery tray to mount the one or more batteries

16. The hot-swappable power system of claim 15 wherein the power module receiver is configured to releasably receive the battery tray.

17. A hot-swappable power system comprising:
a hot-swappable power module that includes one or more batteries and is configured to provide electrical power to an autonomous robotic system; and
a power module receiver configured to receive the hot-swappable power module and releasably electrically couple the hot-swappable power module to a primary energy source of the autonomous robotic system;
wherein the autonomous robotic system includes a robotic arm system.

18. The hot-swappable power system of claim 17 wherein the robotic arm system is powered by the primary energy source.

19. The hot-swappable power system of claim 18 wherein the hot-swappable power module is configured to provide the electrical power to the primary energy source of the robotic arm system

20. The hot-swappable power system of claim 19 wherein the autonomous robotic system also includes an autonomous mobile robot.

21. The hot-swappable power system of claim 20 wherein the autonomous mobile robot is powered by the primary energy source of the robotic arm system.

21. The hot-swappable power system of claim 17 wherein the hot-swappable power module includes a battery tray to mount the one or more batteries

22. The hot-swappable power system of claim 21 wherein the power module receiver is configured to releasably receive the battery tray.
